(19) United States
(12) Patent Application Publication
(10) Pub. No.: US 2025/0118762 A1
(43) Pub. Date: Apr. 10, 2025

(54) ELECTRODE BODY AND BATTERY

(71) Applicant: TOYOTA JIDOSHA KABUSHIKI KAISHA, Aichi-ken (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/893,978

(22) Filed: Sep. 24, 2024

(30) Foreign Application Priority Data
Oct. 5, 2023 (JP) 2023-173836

(51) Int. Cl. H01M 4/62; H01M 4/02; H01M 10/0525

(52) U.S. Cl. CPC H01M 4/625; H01M 10/0525; H01M 2004/028

(57) ABSTRACT

An electrode body including a current collector, a positive electrode layer, and a separator, in this order, the positive electrode layer comprising positive-electrode active material particles and graphite particles, wherein, when the positive electrode layer is divided into two regions in a thickness direction, a number per unit area of the graphite particles in a separator-side region is greater than a number per unit area of the graphite particles in a current collector-side region.

### CROSS-REFERENCE TO RELATED APPLICATION

This application is based on and claims priority under 35 USC 119 from Japanese Patent Application No. 2023-173836 filed on Oct. 5, 2023, the disclosure of which is incorporated by reference herein.

### BACKGROUND

### Technical Field

The present disclosure relates to an electrode body and a battery.

### Related Art

Lithium ion secondary batteries are typically produced by injecting an electrolytic solution into an exterior body in which an electrode body, which includes an electrode and a separator, is accommodated. As a means for increasing an electrode density, the electrode body is subjected to a treatment such as pressing at high pressure or bonding of the electrode to the separator with an adhesive or the like. The treatment may cause difficulty in permeation of the electrolytic solution into the electrode body, and improvement in efficiency of a liquid injection operation is desired.

As a method for improving the permeability of an electrolytic solution into an electrode body, for example, Japanese Patent Application Laid-Open (JP-A) No. 2002-15773 proposes a method of, when bonding an electrode and a separator that constitute an electrode body, providing a portion at which the electrode and the separator are not bonded to each other.

Since the method described in JP-A No. 2002-15773 requires a process of providing a portion at which the electrode and the separator are not bonded to each other in order to increase the permeability with respect to an electrolytic solution, there is room for improvement in operating efficiency.

Further, a positive electrode tends to have a lower permeability with respect to an electrolytic solution than a negative electrode. Therefore, when a positive electrode is bonded to a separator, a migration rate of an electrolytic solution in a planar direction at a border of the positive electrode and the separator is likely to be lowered, thereby impairing the permeability thereof.

### SUMMARY

In view of the foregoing, an object of an embodiment of the present disclosure is to provide an electrode body that includes a positive electrode that exhibits improved permeability with respect to an electrolytic solution; and a battery including the electrode body.

The means for solving the above-described problem include the following embodiments.
<1> An electrode body including a current collector, a positive electrode layer, and a separator, in this order,
the positive electrode layer including positive-electrode active material particles and graphite particles,
wherein, when the positive electrode layer is divided into two regions in a thickness direction, a number per unit area of the graphite particles in a separator-side region is greater than a number per unit area of the graphite particles in a current collector-side region.
<2> An electrode body including a current collector, a positive electrode layer, and a separator, in this order,
the positive electrode layer including positive-electrode active material particles and graphite particles,
wherein, when the positive electrode layer is divided into two regions in a thickness direction, a proportion by area of a domain corresponding to the graphite particles in a separator-side region is greater than a proportion by area of a domain corresponding to the graphite particles in a current collector-side region.
<3> An electrode body including a current collector, a positive electrode layer, and a separator, in this order,
the positive electrode layer including positive-electrode active material particles and graphite particles,
wherein, when the positive electrode layer is divided into two regions in a thickness direction, an average particle size of the graphite particles in a separator-side region is greater than an average particle size of the graphite particles in a current collector-side region.
<4> An electrode body including a current collector, a positive electrode layer, and a separator, in this order,
the positive electrode layer including positive-electrode active material particles and graphite particles,
wherein, when the positive electrode layer is divided into three regions in a thickness direction, a number per unit area of the graphite particles in a central region is greater than a number per unit area of the graphite particles in a current collector-side region and a number per unit area of the graphite particles in a separator-side region.
<5> An electrode body including a current collector, a positive electrode layer, and a separator, in this order,
the positive electrode layer including positive-electrode active material particles and graphite particles,
wherein, when the positive electrode layer is divided into three regions in a thickness direction, a proportion by area of a domain corresponding to the graphite particles in a central region is greater than a proportion by area of a domain corresponding to the graphite particles in a current collector-side region and a proportion by area of a domain corresponding the graphite particles in a separator-side region.
<6> An electrode body including a current collector, a positive electrode layer, and a separator, in this order,
the positive electrode layer including positive-electrode active material particles and graphite particles,
wherein, when the positive electrode layer is divided into three regions in a thickness direction, an average particle size of the graphite particles in a central region is greater than an average particle size of the graphite particles in a current collector-side region and an average particle size of the graphite particles in a separator-side region.
<7> The electrode body according to any one of <1> to <6>, wherein at least a portion of the separator is bonded to the positive electrode layer.
<8> A battery including the electrode body according to any one of <1> to <6>.

According to an object of an embodiment of the present disclosure, it is possible to provide an electrode body that includes a positive electrode that exhibits improved permeability with respect to an electrolytic solution; and a battery including the electrode body.

### BRIEF DESCRIPTION OF THE DRAWINGS

Exemplary embodiments of the present disclosure will be described in detail based on the following figures, wherein:

FIG. 1 is a sectional view schematically illustrating an example of a configuration of an electrode body;

FIG. 2 is a sectional view schematically illustrating an example of a configuration of an electrode body;

FIG. 3 is a diagram schematically illustrating an example of application of a battery to an electric vehicle;

FIG. 4 is a diagram schematically illustrating an example of a configuration of a battery module;

FIG. 5 is a diagram schematically illustrating an example of a configuration of a battery module; and

FIG. 6 is a diagram schematically illustrating an example of a configuration of a battery cell included in a battery module.

### DETAILED DESCRIPTION

In the present disclosure, a numerical range indicated by using “to” means a range in which numerical values described before and after “to” are included as a minimum value and a maximum value, respectively.

In numerical ranges described in the present disclosure in a stepwise manner, an upper limit value or a lower limit value described in a certain numerical range may be replaced with an upper limit value or a lower limit value of another numerical range described in a stepwise manner. In the numerical ranges described in the present disclosure, an upper limit value or a lower limit value described in a certain numerical range may be replaced with a value indicated in the examples.

In the present disclosure, the term “step” includes not only independent steps, and even in a case in which a step cannot be clearly distinguished from another step, it is encompassed by this term as long as the intended purpose of the step is achieved.

In a case in which an exemplary embodiment is explained in the present disclosure with reference to the drawings, the configuration of the exemplary embodiment is not limited to the configuration illustrated in the drawings. Furthermore, sizes of members in the respective drawings are conceptual, and relative relationships between sizes of members are not limited thereto.

### First Embodiment

A first embodiment of the present disclosure is an electrode body including a current collector, a positive electrode layer, and a separator, in this order,
the positive electrode layer including positive-electrode active material particles and graphite particles,
wherein, when the positive electrode layer is divided into two regions in a thickness direction, a number per unit area of the graphite particles in a region at a side of the separator is greater than a number per unit area of the graphite particles in a region at a side of the current collector.

In the electrode body of the present embodiment, the positive electrode layer includes graphite particles. By including graphite particles, appropriate spaces that serve as a migration path for an electrolytic solution, by which permeation of an electrolytic solution is facilitated, are formed inside the positive electrode layer.

On the other hand, an increase in spaces in the positive electrode layer causes a decrease in energy density of a battery. In particular, a portion of the positive electrode layer located close to the current collector is desired to include the positive-electrode active material at high density.

In the electrode body of the present embodiment, a decrease in energy density is suppressed while improving the permeability with respect to an electrolytic solution, by disposing a greater amount of graphite particles at a portion of the positive electrode layer located close to the current collector.

The electrode body of the present embodiment exhibits favorable permeability with respect to an electrolytic solution even in a case in which at least a portion of the separator is bonded to the positive electrode layer.

In the present embodiment, the comparison of a number per unit area of the graphite particles in a separator-side region with a number per unit area of the graphite particles in a current collector-side region may be performed by image analysis.

Specifically, an image of a cross-section of the positive electrode layer in a thickness direction is obtained with a scanning electron microscope, and the image is divided into two regions in the thickness direction.

The location of the border between the two regions is determined such that a thickness of the separator-side region is from 0.5 times to 1.5 times (for example, 1.0 time) as thick as a thickness of the current collector-side region.

Subsequently, the number per unit area of the graphite particles in each region is measured and compared. The dimension of a measurement field of the positive electrode layer is set to at least 10 mm in a planar direction.

In order to increase the accuracy of the measurement, it is possible to obtain plural images of a cross-section of the positive electrode layer in the thickness direction at plural locations of the positive electrode layer (for example, 5 to 10) and compare the numbers per unit area of graphite particles in the images.

The number per unit area of graphite particles at a separator-side region N1 and the number per unit area of graphite particles at a current collector-side region N2 are not particularly limited as long as a relationship represented by N1/N2>1 is satisfied.

From the viewpoint of improving the permeability with respect to an electrolytic solution while suppressing a decrease in energy density, the value of N1/N2 is preferably 1.5 or more, and more preferably 2.0 or more.

The upper limit of N1/N2 is not particularly limited, and may be ∞ (i.e., N2 is zero).

The positive electrode layer may have a configuration in which the separator-side region includes graphite particles as a conductive material, and the current collector-side region includes carbon black as a conductive material.

### Second Embodiment

A second embodiment of the present disclosure is an electrode body including a current collector, a positive electrode layer, and a separator, in this order,
the positive electrode layer including positive-electrode active material particles and graphite particles,
wherein, when the positive electrode layer is divided into two regions in a thickness direction, a proportion by area of a domain corresponding to the graphite particles in a separator-side region is greater than a proportion by area of a domain corresponding to the graphite particles in a current collector-side region.

In the electrode body of the present embodiment, the positive electrode layer includes graphite particles. By including graphite particles, appropriate spaces that serve as a migration path for an electrolytic solution, by which permeation of an electrolytic solution is facilitated, are formed inside the positive electrode layer.

On the other hand, an increase in spaces in the positive electrode layer causes a decrease in energy density of a battery. In particular, a portion of the positive electrode layer located close to the current collector is desired to include the positive-electrode active material at high density.

In the electrode body of the present embodiment, a decrease in energy density is suppressed while improving the permeability with respect to an electrolytic solution, by disposing graphite particles at a higher density at a portion of the positive electrode layer located close to the current collector.

The electrode body of the present embodiment exhibits favorable permeability with respect to an electrolytic solution even in a case in which at least a portion of the separator is bonded to the positive electrode layer.

In the present embodiment, the comparison of a proportion by area of a domain corresponding to graphite particles in a separator-side region with a proportion by area of a domain corresponding to graphite particles in a current collector-side region may be performed by image analysis.

Specifically, an image of a cross-section of the positive electrode layer in a thickness direction is obtained with a scanning electron microscope, and the image is divided into two regions in the thickness direction.

The location of the border between the two regions is determined such that a thickness of the separator-side region is from 0.5 times to 1.5 times (for example, 1.0 time) as thick as a thickness of the current collector-side region.

Subsequently, the proportion by area of a domain corresponding to graphite particles in each region is measured and compared. The dimension of a measurement field of the positive electrode layer is set to at least 10 mm in a planar direction.

The proportion by area of a domain corresponding to graphite particles is obtained by dividing an area of a domain corresponding to graphite particles in the measurement field of the positive electrode layer by an area of the measurement field (i.e., a total area of a region corresponding to graphite particles and a region not corresponding to graphite particles). As necessary, the image may be subjected to binary image processing or the like when determining the region corresponding to graphite particles.

In order to increase the accuracy of the measurement, it is possible to obtain plural images of a cross-section of the positive electrode layer in the thickness direction at plural locations of the positive electrode layer (for example, 5 to 10) and compare the proportions by area of a domain corresponding to graphite particles in the images.

The proportion by area of a domain corresponding to graphite particles at a separator-side region R1 and the proportion by area of a domain corresponding to graphite particles at a current collector-side region R2 are not particularly limited as long as a relationship represented by R1/R2>1 is satisfied.

From the viewpoint of improving the permeability with respect to an electrolytic solution while suppressing a decrease in energy density, the value of R1/R2 is preferably 1.5 or more, and more preferably 2.0 or more.

The upper limit of R1/R2 is not particularly limited, and may be ∞ (i.e., R2 is zero).

The positive electrode layer may have a configuration in which the separator-side region includes graphite particles as a conductive material, and the current collector-side region includes carbon black as a conductive material.

### Third Embodiment

A third embodiment of the present disclosure is an electrode body including a current collector, a positive electrode layer, and a separator, in this order,
the positive electrode layer including positive-electrode active material particles and graphite particles,
wherein, when the positive electrode layer is divided into two regions in a thickness direction, an average particle size of the graphite particles in a separator-side region is greater than an average particle size of the graphite particles in a current collector-side region.

In the electrode body of the present embodiment, the positive electrode layer includes graphite particles. By including graphite particles, appropriate spaces that serve as a migration path for an electrolytic solution, by which permeation of an electrolytic solution is facilitated, are formed inside the positive electrode layer.

On the other hand, an increase in spaces in the positive electrode layer causes a decrease in energy density of a battery. In particular, a portion of the positive electrode layer located close to the current collector is desired to include the positive-electrode active material at high density.

In the electrode body of the present embodiment, a decrease in energy density is suppressed while improving the permeability with respect to an electrolytic solution, by disposing graphite particles with a greater size at a portion of the positive electrode layer located close to the current collector.

The electrode body of the present embodiment exhibits favorable permeability with respect to an electrolytic solution even in a case in which at least a portion of the separator is bonded to the positive electrode layer.

In the present embodiment, the comparison of an average particle size of graphite particles in a separator-side region with an average particle size of graphite particles in a current collector-side region may be performed by image analysis.

Specifically, an image of a cross-section of the positive electrode layer in a thickness direction is obtained with a scanning electron microscope, and the image is divided into two regions in the thickness direction.

The location of the border between the two regions is determined such that a thickness of the separator-side region is from 0.5 times to 1.5 times (for example, 1.0 time) as thick as a thickness of the current collector-side region.

Subsequently, the average particle size of graphite particles in each region is measured and compared. The dimension of a measurement field of the positive electrode layer is set to at least 10 mm in a planar direction.

The average particle size of graphite particles is obtained as an arithmetic average value of measured particles sizes of 100 graphite particles that are arbitrarily selected in the measurement filed of the positive electrode layer. The particle size of a graphite particle may be determined based on a length of the major axis, an equivalent circle diameter (a diameter of a circle having an area equivalent to an area of a projection image of a particle) or the like.

In order to increase the accuracy of the measurement, it is possible to obtain plural images of a cross-section of the positive electrode layer in the thickness direction at plural locations of the positive electrode layer (for example, 5 to 10) and compare the average particle sizes of graphite particles in the images.

The average particle size of graphite particles at a separator-side region D1 and the average particle size of graphite particles at a current collector-side region D2 are not particularly limited as long as a relationship represented by D1/D2>1 is satisfied.

From the viewpoint of improving the permeability with respect to an electrolytic solution while suppressing a decrease in energy density, the value of D1/D2 is preferably 1.5 or more, and more preferably 2.0 or more.

The upper limit of D1/D2 is not particularly limited, and may be ∞ (i.e., D2 is zero).

The positive electrode layer may have a configuration in which the separator-side region includes graphite particles as a conductive material, and the current collector-side region includes carbon black as a conductive material.

### Fourth Embodiment

A fourth embodiment of the present disclosure is an electrode body including a current collector, a positive electrode layer, and a separator, in this order,
the positive electrode layer including positive-electrode active material particles and graphite particles,
wherein, when the positive electrode layer is divided into three regions in a thickness direction, a number per unit area of the graphite particles in a central region is greater than a number per unit area of the graphite particles in a current collector-side region and a number per unit area of the graphite particles in a separator-side region.

In the electrode body of the present embodiment, the positive electrode layer includes graphite particles. By including graphite particles, appropriate spaces that serve as a migration path for an electrolytic solution, by which permeation of an electrolytic solution is facilitated, are formed inside the positive electrode layer.

On the other hand, an increase in spaces in the positive electrode layer causes a decrease in energy density of a battery. In particular, a portion of the positive electrode layer located close to the current collector is desired to include the positive-electrode active material at high density. Further, from the viewpoint of minimizing a pathway for an electrolytic solution to migrate in the thickness direction of the positive electrode layer, it is effective to increase the permeability with respect to an electrolytic solution at a region around the center of the positive electrode layer.

In the electrode body of the present embodiment, a decrease in energy density is suppressed while improving the permeability with respect to an electrolytic solution, by disposing a greater amount of graphite particles at a portion located close to the center of the positive electrode layer.

The electrode body of the present embodiment exhibits favorable permeability with respect to an electrolytic solution even in a case in which at least a portion of the separator is bonded to the positive electrode layer.

In the present embodiment, the comparison of a number per unit area of graphite particles in a central region with a number per unit area of graphite particles in a separator-side region and a number per unit area of graphite particles in a current collector-side region may be performed by image analysis.

Specifically, an image of a cross-section of the positive electrode layer in a thickness direction is obtained with a scanning electron microscope, and the image is divided into three regions in the thickness direction.

The location of the border between the three regions is determined such that a thickness of the central region is from 0.5 times to 1.5 times (for example, 1.0 time) as thick as a thickness of the separator-side region and a thickness of the current collector-side region.

Subsequently, the number per unit area of the graphite particles in each region is measured and compared in the same manner as the method described in the first embodiment.

The number per unit area of graphite particles at a central region N0, the number per unit area of graphite particles at a separator-side region N1, and the number per unit area of graphite particles at a current collector-side region N2 are not particularly limited as long as relationships represented by N0/N1>1 and N0/N2>1 are satisfied.

From the viewpoint of improving the permeability with respect to an electrolytic solution while suppressing a decrease in energy density, the values of N0/N1>1 and N0/N2>1 are preferably 1.5 or more, and more preferably 2.0 or more.

The upper limit of N0/N1 is not particularly limited, and may be ∞ (i.e., N1 is zero).

The upper limit of N0/N2 is not particularly limited, and may be ∞ (i.e., N2 is zero).

The positive electrode layer may have a configuration in which the separator-side region includes graphite particles as a conductive material, and the current collector-side region includes carbon black as a conductive material.

### Fifth Embodiment

A fifth embodiment of the present disclosure is an electrode body including a current collector, a positive electrode layer, and a separator, in this order,
the positive electrode layer comprising positive-electrode active material particles and graphite particles,
wherein, when the positive electrode layer is divided into three regions in a thickness direction, a proportion by area of a domain corresponding to the graphite particles in a central region is greater than a proportion by area of a domain corresponding to the graphite particles in a current collector-side region and a proportion by area of a domain corresponding the graphite particles in a separator-side region.

In the electrode body of the present embodiment, the positive electrode layer includes graphite particles. By including graphite particles, appropriate spaces that serve as a migration path for an electrolytic solution, by which permeation of an electrolytic solution is facilitated, are formed inside the positive electrode layer.

On the other hand, an increase in spaces in the positive electrode layer causes a decrease in energy density of a battery. In particular, a portion of the positive electrode layer located close to the current collector is desired to include the positive-electrode active material at high density. Further, from the viewpoint of minimizing a pathway for an electrolytic solution to migrate in the thickness direction of the positive electrode layer, it is effective to increase the permeability with respect to an electrolytic solution at a region around the center of the positive electrode layer.

In the electrode body of the present embodiment, a decrease in energy density is suppressed while improving the permeability with respect to an electrolytic solution, by disposing graphite particles at a higher density at a portion located close to the center of the positive electrode layer.

The electrode body of the present embodiment exhibits favorable permeability with respect to an electrolytic solution even in a case in which at least a portion of the separator is bonded to the positive electrode layer.

In the present embodiment, the comparison of a proportion by area of a domain corresponding to graphite particles in a central region with a proportion by area of a domain corresponding to graphite particles in a separator-side region and a proportion by area of a domain corresponding to graphite particles in a current collector-side region may be performed by image analysis.

Specifically, an image of a cross-section of the positive electrode layer in a thickness direction is obtained with a scanning electron microscope, and the image is divided into three regions in the thickness direction.

The location of the border between the three regions is determined such that a thickness of the central region is from 0.5 times to 1.5 times (for example, 1.0 time) as thick as a thickness of the separator-side region and a thickness of the current collector-side region.

Subsequently, the proportion by area of a domain corresponding to graphite particles in each region is measured and compared in the same manner as the method described in the second embodiment.

The proportion by area of a domain corresponding to graphite particles at a central region R0, the proportion by area of a domain corresponding to graphite particles at a separator-side region R1, and the proportion by area of a domain corresponding to graphite particles at a current collector-side region R2 are not particularly limited as long as relationships represented by R0/R1>1 and R0/R2>1 are satisfied.

From the viewpoint of improving the permeability with respect to an electrolytic solution while suppressing a decrease in energy density, the values of R0/R1>1 and R0/R2>1 are preferably 1.5 or more, and more preferably 2.0 or more.

The upper limit of R0/R1 is not particularly limited, and may be ∞ (i.e., R1 is zero).

The upper limit of R0/R2 is not particularly limited, and may be ∞ (i.e., R2 is zero).

The positive electrode layer may have a configuration in which the separator-side region includes graphite particles as a conductive material, and the current collector-side region includes carbon black as a conductive material.

### Sixth Embodiment

A sixth embodiment of the present disclosure is an electrode body including a current collector, a positive electrode layer, and a separator, in this order,
the positive electrode layer comprising positive-electrode active material particles and graphite particles,
wherein, when the positive electrode layer is divided into three regions in a thickness direction, an average particle size of the graphite particles in a central region is greater than an average particle size of the graphite particles in a current collector-side region and an average particle size of the graphite particles in a separator-side region.

In the electrode body of the present embodiment, the positive electrode layer includes graphite particles. By including graphite particles, appropriate spaces that serve as a migration path for an electrolytic solution, by which permeation of an electrolytic solution is facilitated, are formed inside the positive electrode layer.

On the other hand, an increase in spaces in the positive electrode layer causes a decrease in energy density of a battery. In particular, a portion of the positive electrode layer located close to the current collector is desired to include the positive-electrode active material at high density. Further, from the viewpoint of minimizing a pathway for an electrolytic solution to migrate in the thickness direction of the positive electrode layer, it is effective to increase the permeability with respect to an electrolytic solution at a region around the center of the positive electrode layer.

In the electrode body of the present embodiment, a decrease in energy density is suppressed while improving the permeability with respect to an electrolytic solution, by disposing graphite particles with a greater size at a portion located close to the center of the positive electrode layer.

The electrode body of the present embodiment exhibits favorable permeability with respect to an electrolytic solution even in a case in which at least a portion of the separator is bonded to the positive electrode layer.

In the present embodiment, the comparison of an average particle size of graphite particles in a central region with an average particle size of graphite particles in a separator-side region and an average particle size of graphite particles in a current collector-side region may be performed by image analysis.

Specifically, an image of a cross-section of the positive electrode layer in a thickness direction is obtained with a scanning electron microscope, and the image is divided into three regions in the thickness direction.

The location of the border between the three regions is determined such that a thickness of the central region is from 0.5 times to 1.5 times (for example, 1.0 time) as thick as a thickness of the separator-side region and a thickness of the current collector-side region.

Subsequently, the average particle size of the graphite particles in each region is measured and compared in the same manner as the method described in the third embodiment.

The average particle size of graphite particles at a central region D0, the average particle size of graphite particles at a separator-side region D1, and the average particle size of graphite particles at a current collector-side region D2 are not particularly limited as long as relationships represented by D0/D1>1 and D0/D2>1 are satisfied.

From the viewpoint of improving the permeability with respect to an electrolytic solution while suppressing a decrease in energy density, the values of N0/N1>1 and D0/D2>1 are preferably 1.5 or more, and more preferably 2.0 or more.

The upper limit of D0/D1 is not particularly limited, and may be ∞ (i.e., D1 is zero).

The upper limit of D0/D2 is not particularly limited, and may be ∞ (i.e., D2 is zero).

The positive electrode layer may have a configuration in which the separator-side region includes graphite particles as a conductive material, and the current collector-side region includes carbon black as a conductive material.

### Properties of Battery

The electrode body of the present disclosure corresponds to at least one selected from the first embodiment to sixth embodiment as stated above.

In the electrode body, the amount of the graphite particles included in the positive electrode layer is not particularly limited, and may be selected from a range in which the functions of the positive electrode layer are not impaired.

From the viewpoint of improving the permeability with respect to an electrolytic solution while suppressing a decrease in energy density, the amount (g) of the graphite particles included in the positive electrode layer may be from 1% to 10% of the amount (g) of the positive-electrode active material particles.

The graphite particles may function as a conductive material in the positive electrode layer.

The thickness of the positive electrode layer is not particularly limited, and may be selected from a thickness of typical positive electrode layers.

For example, the thickness of the positive electrode layer may be selected from a range of from 10 μm to 200 μm.

The electrode body may include plural positive electrode layers. In that case, it is possible that some of the positive electrode layers satisfy the conditions of the aforementioned embodiments, or it is possible that all of the plural positive electrode layers satisfy the conditions of the aforementioned embodiments.

The particle size of the graphite particles included in the positive electrode material is not particularly limited, and may be selected from a range of from 5 μm to 30 μm. The graphite particles may have any shape without particular restriction, and may be in the form of scales, spheres, secondary particles composed of primary particles, or the like. When the graphite particles are in the form of secondary particles, the particle size as mentioned above refers to a particle size of the secondary particles.

The type of the positive-electrode active material particles included in the positive electrode layer is not particularly limited, and may be selected from those commonly used as a positive-electrode active material for a battery.

Examples of positive-electrode active material particles include composite oxides formed of lithium and a transition metal, and optionally other metals (hereinafter, also referred to as lithium transition metal composite oxides). Examples of the transition metal and other metals include Ni, Co, Mn, Al, B, Mg, Ti, V, Cr, Fe, Cu, Zn, Ga, Sr, Zr, Nb, In, Sn, Ta, W, and the like. Among these, lithium transition metal composite oxides including at least one selected from Ni, Co or Mn are preferred, and lithium transition metal composite oxides including Ni, Co and Mn (NCM, nickel-cobalt-manganese oxides) are more preferred.

Examples of the lithium transition metal composite oxide include lithium cobalt oxide (LiCoO₂), lithium nickel oxide (LiNiO₂), lithium manganese oxide (LiMnO₂), composite oxides thereof (LiCoₓNi_{y}Mn_{z}O₂, x+y+z=1), composite oxides further including an additional element M′ (LiCoₐNi_{b}Mn_{c}M′_{d}O₂, a+b+c+d=1, M′ is Al, Mg, Ti, Zr or Ge), spinel-type lithium transition metal composite oxides (LiMn₂O₄), and olivine-type lithium transition metal composite oxides (LiMPO₄, M is Co, Ni, Mn or Fe).

The positive-electrode active material particles contained in the positive electrode layer may be one kind alone, or may be two or more kinds thereof.

The particle size of the positive-electrode active material particles is not particularly limited, and may be selected from a range of from 5 μm to 30 μm. The shape of the positive-electrode active material particles is not particularly limited, and may be scale-shape, spherical, secondary particles composed of primary particles, or the like. When the positive-electrode active material particles are secondary particles, the particle size as mentioned above refers to a particle size of the secondary particles.

The positive electrode layer may include a conductive material other than the graphite particles, as necessary.

Specific examples of the conductive material include carbon materials such as carbon black (such as acetylene black, thermal black and furnace black) and carbon nanotube.

The conductive material contained in the positive electrode layer may be one kind alone, or may be two or more kinds thereof.

The positive electrode layer may include a binder as necessary.

Specific examples of the binder include polyvinylidene fluoride (PVdF), polyethylene, polypropylene, polyethylene terephthalate, cellulose, nitro cellulose, carboxymethyl cellulose, polyethylene oxide, polyepichlorohydrin, polyacrylonitrile, styrene-butadiene rubber (SBR), acrylonitrile-butadiene rubber (NBR), polyacrylate, polymethacrylate and polytetrafluoroethylene (PTFE).

The binder contained in the positive electrode layer may be one kind alone, or may be two or more kinds thereof.

### Current Collector

The type of the current collector included in the electrode body is not particularly limited, and may be selected from those commonly used as a current collector for a battery.

For example, a current collector containing cupper may be used as a current collector for a negative electrode, and a current collector containing aluminum may be used as a current collector for a positive electrode.

The thickness of the current collector may be selected from 5 μm to 50 μm, for example.

### Method for Producing Positive Electrode Layer

The method for producing the positive electrode layer is not particularly limited, and may be selected from known methods.

For example, the electrode layer may be formed by applying, onto one or both faces of the current collector, a composition for forming a positive electrode layer. It is possible to produce a positive electrode layer that satisfies the conditions of the present disclosure by preparing two or more compositions, in which the amount or the particle size of the graphite particles is different from each other, and applying the compositions onto the current collector in a sequential manner.

### Exemplary Configurations of Electrode Body

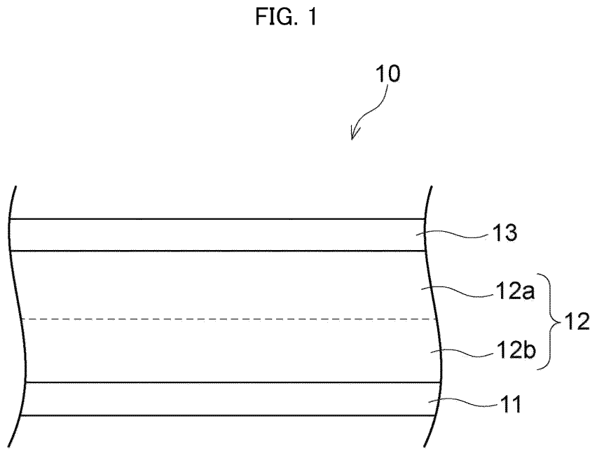

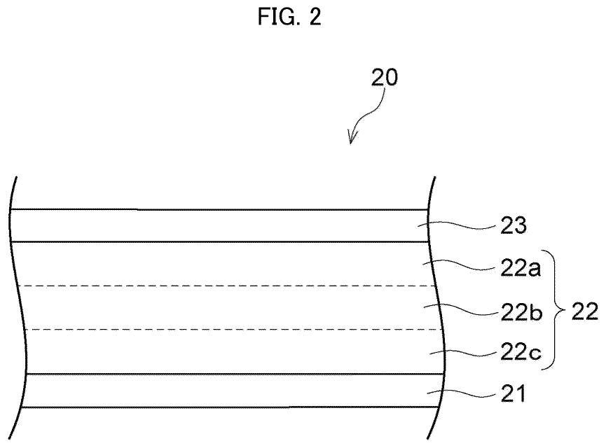

Exemplary configurations of the electrode body of the present disclosure are shown in FIG. 1 and FIG. 2.

Electrode body 10, illustrated in FIG. 1, includes current collector 11, positive electrode layer 12, and separator 13 in this order.

Positive electrode layer 12 is divided into region 12A at a side of separator 13 and region 12b at a side of current collector 11. Region 12a and region 12b may be separated by a distinct border, or may not be separated by a distinct border.

When positive electrode layer 12 consists of plural layers of different compositions, the border between the layers may be consistent with the border between region 12a and region 12b, or may not be consistent with the border between region 12a and region 12b.

Electrode body 10 may include a negative electrode layer and a current collector (not shown) at a side of separator 13 opposite to a side of positive electrode layer 12.

Electrode body 20, illustrated in FIG. 2, includes current collector 21, positive electrode layer 22, and separator 23 in this order.

Positive electrode layer 22 is divided into region 22A at a side of separator 23, region 22b at the center, and region 22c at a side of current collector 21. Region 22a, region 22b and region 22c may be separated by a distinct border, or may not be separated by a distinct border.

When positive electrode layer 22 consists of plural layers of different compositions, the border between the layers may be consistent with the border between region 22a, region 22b and region 22c, or may not be consistent with the border between region 22a, region 22b and region 22c.

Electrode body 20 may include a negative electrode layer and a current collector (not shown) at a side of separator 23 opposite to a side of positive electrode layer 22.

### Seventh Embodiment

A seventh embodiment of the present disclosure is a battery including the battery of the present disclosure as mentioned above.

The battery of the present disclosure includes, for example, an electrode body, an exterior body that accommodates the electrode body, and an electrolytic solution.

Specific examples of the battery include secondary batteries such as lithium ion secondary batteries, sodium ion secondary batteries, and potassium ion batteries.

### Exterior Body

The type of the exterior body that accommodates an electrode body is not particularly limited, and may be selected according to the type of a battery.

In an embodiment, an exterior body having a sheet-like shape may be used.

Examples of an exterior body having a sheet-like shape include an exterior body including metal, and specific examples thereof include a layered body that has a metal layer containing a metal such as aluminum and a heat seal layer containing a resin that melts by heating (i.e., a laminate film). Therefore, the battery of the present disclosure may be a battery using a laminate film as an exterior body (i.e., a laminate battery).

The exterior body may be composed of a single member or composed of two or more members. For example, when the exterior body is a sheet-like object, the exterior body may be composed of a single sheet-shaped object or composed of two sheet-shaped objects.

As necessary, a recessed portion for accommodating an electrode body may be formed to the sheet-shaped exterior body by embossing.

Examples of a method for accommodating the electrode body in the exterior body using a sheet-shaped exterior body include, for example, the following Method 1 and Method 2.
Method 1: a method of, in a state in which the electrode body is disposed between one exterior body that has been folded in half or between two exterior bodies that have been superposed, joining the exterior body (or bodies) at a periphery of the electrode body
Method 2: a method of inserting the electrode body into a bag that has been prepared by joining a periphery of one exterior body that has been folded in half or two exterior bodies that have been superposed.

### Electrolytic Solution

The type of the electrolytic solution is not particularly limited, and may be selected according to the type of the battery.

For example, a solution obtained by dissolving an electrolytic substance, such as LiPF₆, in a non-aqueous solvent, may be used as an electrolytic solution.

The battery of the present disclosure may be mounted at an electric vehicle. Hereinafter, an example in which the battery of the present disclosure is applied to an electric vehicle will be explained with reference to the drawings. In the following explanation, a “battery cell 20” corresponds to the battery of the present disclosure.

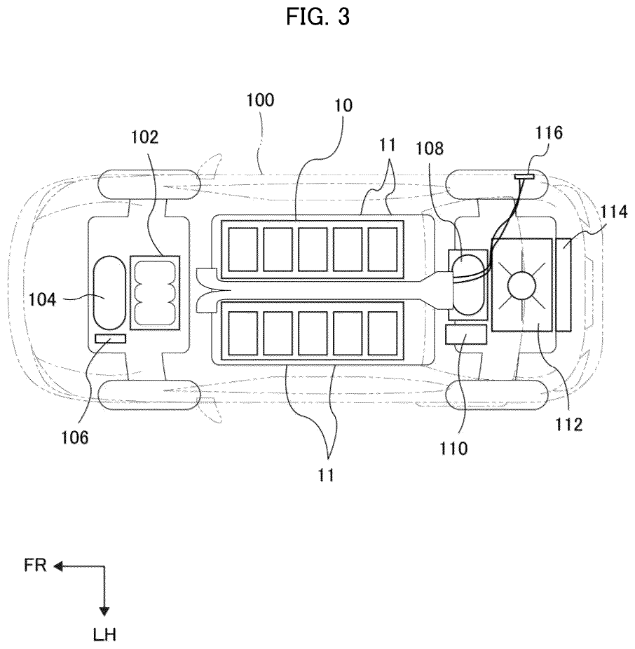

FIG. 3 is a schematic plan view illustrating a main part of a vehicle 100 to which a battery pack 10 according to an embodiment has been applied. As shown in FIG. 3, the vehicle 100 is an electric vehicle (battery electric vehicle (BEV)) in which the battery pack 10 is mounted under a floor. It should be noted that arrow UP, arrow FR, and arrow LH in the respective drawings respectively indicate an upper side in a vehicle up-down direction, a front side in a vehicle front-rear direction, and a left side in a vehicle width direction. In cases in which explanation is given using front-rear, left-right, and up-down directions, unless otherwise specified, these indicate front and rear in the vehicle front-rear direction, left and right in the vehicle width direction, and up and down in the vehicle up-down direction.

As an example, in the vehicle 100 of the present embodiment, a DC/DC converter 102, an electric compressor 104, and a positive temperature coefficient (PTC) heater 106 are disposed further toward a vehicle front side than the battery pack 10. Further, a motor 108, a gear box 110, an inverter 112, and a charger 114 are disposed further toward a vehicle rear side than the battery pack 10.

A DC current that has been output from the battery pack 10 is adjusted in voltage by the DC/DC converter 102, and thereafter supplied to the electric compressor 104, the PTC heater 106, the inverter 112, and the like. Furthermore, due to electric power being supplied to the motor 108 via the inverter 112, rear wheels rotate to drive the vehicle 100.

A charging port 116 is provided at a right side portion of a rear portion of the vehicle 100. By connecting a charging plug of an external charging facility, which is not illustrated in the drawings, from the charging port 116, electric power can be stored in the battery pack 10 via the charger 114.

An arrangement, structure and the like of the respective components configuring the vehicle 100 are not limited to the configuration described above. For example, the present disclosure may be applied to vehicles installed with an engine such as hybrid vehicles (HV) and plug-in hybrid electric vehicles (PHEV). Further, in the present embodiment, although the vehicle is configured as a rear-wheel drive vehicle in which the motor 108 is mounted at the rear portion of the vehicle, there is no limitation thereto; the vehicle may be configured as a front-wheel drive vehicle in which the motor 108 is mounted at the front portion of the vehicle, and a pair of motors 108 may also be mounted at the front and rear of the vehicle. Furthermore, the vehicle may also be provided with in-wheel motors at the respective wheels.

The battery pack 10 is configured to include plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Furthermore, each of the battery modules 11 are electrically connected to each other.

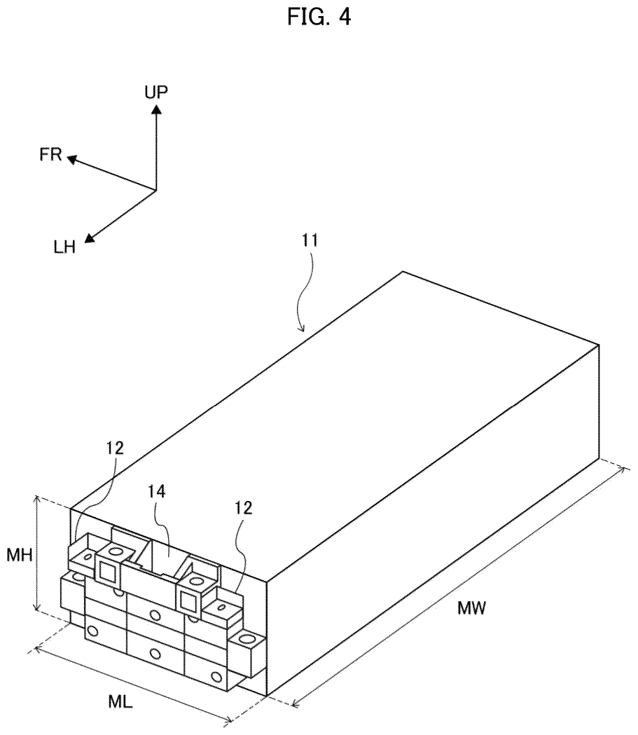

FIG. 4 is a schematic perspective view of a battery module 11. As shown in FIG. 4, the battery module 11 is formed in a substantially rectangular parallelepiped shape having a longitudinal direction along the vehicle width direction. Furthermore, an outer shell of the battery module 11 is formed of an aluminum alloy. For example, the outer shell of the battery module 11 is formed by joining aluminum die-casting to both ends of an extruded material of an aluminum alloy by laser welding or the like.

A pair of voltage terminals 12 and a connector 14 are provided at both ends of the battery module 11 in the vehicle width direction. A flexible printed circuit board 21, which will be described later, is connected to the connector 14. Furthermore, bus bars, which are not illustrated in the drawings, are welded to both ends of the battery module 11 in the vehicle width direction.

A length MW of the battery module 11 in the vehicle width direction is, for example, from 350 mm to 600 mm; a length ML thereof in the vehicle front-rear direction is, for example, from 150 mm to 250 mm; and a height MH thereof in the vehicle up-down direction is, for example, from 80 mm to 110 mm.

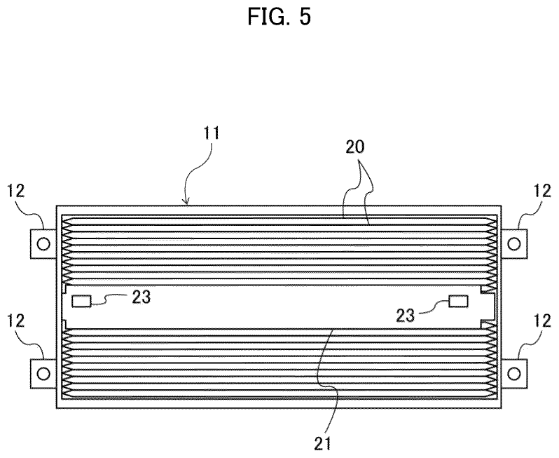

FIG. 5 is a plan view of the battery module 11 in a state in which an upper lid thereof has been removed. As shown in FIG. 5, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is disposed on the battery cells 20. The flexible printed circuit board 21 is formed in a band shape with a longitudinal direction thereof along the vehicle width direction, and thermistors 23 are respectively provided at both end ends of the flexible printed circuit board 21. The thermistors 23 are not adhered to the battery cells 20 and are configured to be pressed toward the battery cells 20 side by the upper lid of the battery module 11.

Furthermore, one or more cushioning materials, which are not illustrated in the drawings, are accommodated at the interior of the battery module 11. For example, the cushioning material is a thin plate-shaped member that is elastically deformable, and is disposed between adjacent battery cells 20 with a thickness direction thereof along an arrangement direction of the battery cells 20. In the present embodiment, as an example, cushioning materials are disposed at both end portions in the longitudinal direction of the battery module 11 and at the center portion in the longitudinal direction of the battery module 11, respectively.

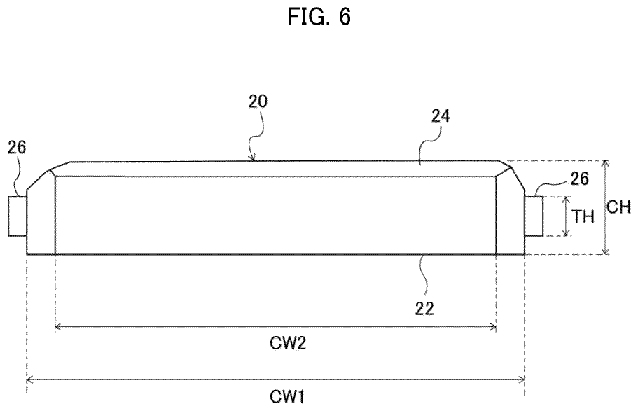

FIG. 6 is a schematic diagram in which a battery cell 20 that is accommodated in the battery module 11 is viewed from a thickness direction thereof. As shown in FIG. 6, the battery cell 20 is formed in a substantially rectangular plate shape, and an electrode body, which is not shown in the drawings, is accommodated at an interior thereof. The electrode body is configured by laminating a positive electrode, a negative electrode, and a separator, and is sealed by a laminate film 22.

In the present embodiment, as an example, the embossed, sheet-shaped laminate film 22 is folded and bonded to thereby form a housing portion of the electrode body. The laminate film 22 may have either a single-cup embossing structure in which embossing is at one place or a double-cup embossing structure in which embossing is at two places. In an embodiment, the laminate film 22 has a single-cup embossing structure with a draw depth of from about 8 mm to 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. An electrode body comprising a current collector, a positive electrode layer, and a separator, in this order,
the positive electrode layer comprising positive-electrode active material particles and graphite particles,
wherein, when the positive electrode layer is divided into two regions in a thickness direction, a number per unit area of the graphite particles in a separator-side region is greater than a number per unit area of the graphite particles in a current collector-side region.

2. An electrode body comprising a current collector, a positive electrode layer, and a separator, in this order,
the positive electrode layer comprising positive-electrode active material particles and graphite particles,
wherein, when the positive electrode layer is divided into two regions in a thickness direction, a proportion by area of a domain corresponding to the graphite particles in a separator-side region is greater than a proportion by area of a domain corresponding to the graphite particles in a current collector-side region.

3. An electrode body comprising a current collector, a positive electrode layer, and a separator, in this order,
the positive electrode layer comprising positive-electrode active material particles and graphite particles,
wherein, when the positive electrode layer is divided into two regions in a thickness direction, an average particle size of the graphite particles in a separator-side region is greater than an average particle size of the graphite particles in a current collector-side region.

4. An electrode body comprising a current collector, a positive electrode layer, and a separator, in this order,
the positive electrode layer comprising positive-electrode active material particles and graphite particles,
wherein, when the positive electrode layer is divided into three regions in a thickness direction, a number per unit area of the graphite particles in a central region is greater than a number per unit area of the graphite particles in a current collector-side region and a number per unit area of the graphite particles in a separator-side region.

5. An electrode body comprising a current collector, a positive electrode layer, and a separator, in this order,
the positive electrode layer comprising positive-electrode active material particles and graphite particles,
wherein, when the positive electrode layer is divided into three regions in a thickness direction, a proportion by area of a domain corresponding to the graphite particles in a central region is greater than a proportion by area of a domain corresponding to the graphite particles in a current collector-side region and a proportion by area of a domain corresponding the graphite particles in a separator-side region.

6. An electrode body comprising a current collector, a positive electrode layer, and a separator, in this order,
the positive electrode layer comprising positive-electrode active material particles and graphite particles,
wherein, when the positive electrode layer is divided into three regions in a thickness direction, an average particle size of the graphite particles in a central region is greater than an average particle size of the graphite particles in a current collector-side region and an average particle size of the graphite particles in a separator-side region.

7. The electrode body according to claim 1, wherein at least a portion of the separator is bonded to the positive electrode layer.

8. A battery comprising the electrode body according to claim 1.

9. The electrode body according to claim 2, wherein at least a portion of the separator is bonded to the positive electrode layer.

10. A battery comprising the electrode body according to claim 2.

11. The electrode body according to claim 3, wherein at least a portion of the separator is bonded to the positive electrode layer.

12. A battery comprising the electrode body according to claim 3.

13. The electrode body according to claim 4, wherein at least a portion of the separator is bonded to the positive electrode layer.

14. A battery comprising the electrode body according to claim 4.

15. The electrode body according to claim 5, wherein at least a portion of the separator is bonded to the positive electrode layer.

16. A battery comprising the electrode body according to claim 5.

17. The electrode body according to claim 6, wherein at least a portion of the separator is bonded to the positive electrode layer.

18. A battery comprising the electrode body according to claim 6.
